(19) United States
(12) Patent Application Publication
(10) Pub. No.: US 2013/0346704 A1
(43) Pub. Date: Dec. 26, 2013

(54) Indicating Cached Content Status

(71) Applicants: Douglas Christopher Burger, Bellevue, WA (US); Anoop Gupta, Woodinville, WA (US); Jie Liu, Medina, WA (US)

(72) Inventors: Douglas Christopher Burger, Bellevue, WA (US); Anoop Gupta, Woodinville, WA (US); Jie Liu, Medina, WA (US)

(73) Assignee: MICROSOFT CORPORATION, Redmond, WA (US)

(21) Appl. No.: 13/530,930

(22) Filed: Jun. 22, 2012

(51) Int. Cl. G06F 12/08

(52) U.S. Cl. 711/137; 711/118; 711/E12.057

(57) ABSTRACT

Described is a technology by which a link to content is visibly augmented to convey information related to a cached status of the linked-to content. In one aspect, a cached versus not cached indication may be provided to convey such cache-related information to a user. Staleness of cached content also may be indicated. Also described is pre-fetching and/or updating cache content, which may be conveyed to the user by the conveyed cache-related status information.

### BACKGROUND

Consumer devices such as laptop computers, smartphones, tablet computers, and personal computers are relying more and more on network and cloud (remote) services to back up their data and provide synchronization. Devices with limited bandwidth due to low-bandwidth cellular connections or poor Wi-Fi connections, and/or devices with limited battery life, benefit from caching relevant data on the devices. Using locally cached data rather than obtaining data from a remote source facilitates low-energy, near-instantaneous data access. Moreover, using less bandwidth is beneficial to service providers as well as consumers, particularly consumers who do not have unlimited data plans.

However, contemporary caching is relatively primitive, in that a piece of content that is downloaded is simply kept locally cached for awhile in case the user wants to access that piece of content again. That saves some bandwidth and power, but not in many browsing or other content download instances. In general, any improvements in cache usage and content caching are desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which cache-related status of content corresponding to a link is obtained, with the link rendered in a manner that indicates the cache-related status. In one aspect, when the cache-related status indicates that the content is cached, the link is rendered in a manner that visibly augments a displayed representation of the link. Visibly augmenting the displayed representation of the link may include changing the appearance of the displayed representation of the link relative to when the content is not cached, and/or associating an icon with the displayed visible representation of the link. Such an icon may convey additional information.

In one aspect, a memory and one or more processors provide a system that writes content to a cache, obtains cache-related status information of content corresponding to a link, and renders the link based upon the cache-related status information to convey the cache-related status of the content corresponding to the link. The processor or processors may be configured to execute code that pre-fetches content into the cache, and/or updates content in the cache.

In one aspect, there is described determining whether a piece of content corresponding to a link is cached. If not cached, a visible representation of the link is rendered in one mode; if cached, a visible representation of the link is rendered in another mode. The determination may include a distinction as to whether the cached piece of content is stale or not stale. If cached and not stale, the visible representation of the link may be rendered in a cached and not stale mode. If cached but stale, the visible representation of the link may be rendered in a cached but stale mode.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a system that indicates cached content status according to one example embodiment.

FIGS. 2A and 2B are representations of how a link rendering may convey cached content status according to one example embodiment.

FIGS. 3A and 3B are representations of how a link rendering may convey cached content status via an icon according to one example embodiment.

FIG. 4 is a flow diagram representing example steps that may be taken to obtain cache-related status of content corresponding to a link, and use that cache-related status for rendering a link to convey cached content status according to one example embodiment.

FIG. 5 is a block diagram representing an example computing environment into which aspects of the subject matter described herein may be incorporated.

### DETAILED DESCRIPTION

Various aspects of the technology described herein are generally directed towards cache usage, and in particular to mechanisms that use the cache and cache-related information in a way that saves bandwidth with respect to content downloads. In one aspect, a link is visibly altered in some way to indicate the state of the content with respect to caching, e.g., cached and fresh, not cached, or cached but stale. This visible indication influences a user's decision as to whether to view the content associated with a link, e.g., a user is more likely to view content if cached than if not cached, possibly with a content freshness decision also contemplated.

In another aspect, information as to what is cached on a user device may be sent to a server (or maintained in synchronization at the server). This allows a server to only refresh cached content that is stale. This further allows a server to download only changes (deltas) to cached content that is stale.

It should be understood that any of the examples herein are non-limiting. For one, conventional links to remote content are exemplified as one type of link that may be augmented, however, as used herein, a “link” refers to any interactive reference to remote content that may be locally downloaded/cached, including conventional links, Windows® “Metro” tiles for a program that link to remote content (such as tiles in a news application that link to a story), links to file shares (e.g., for files that are actually links to be synchronized later), and so on. Each of these types of links as well as others not explicitly described may be augmented so as to indicate a different caching state. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and content caching in general.

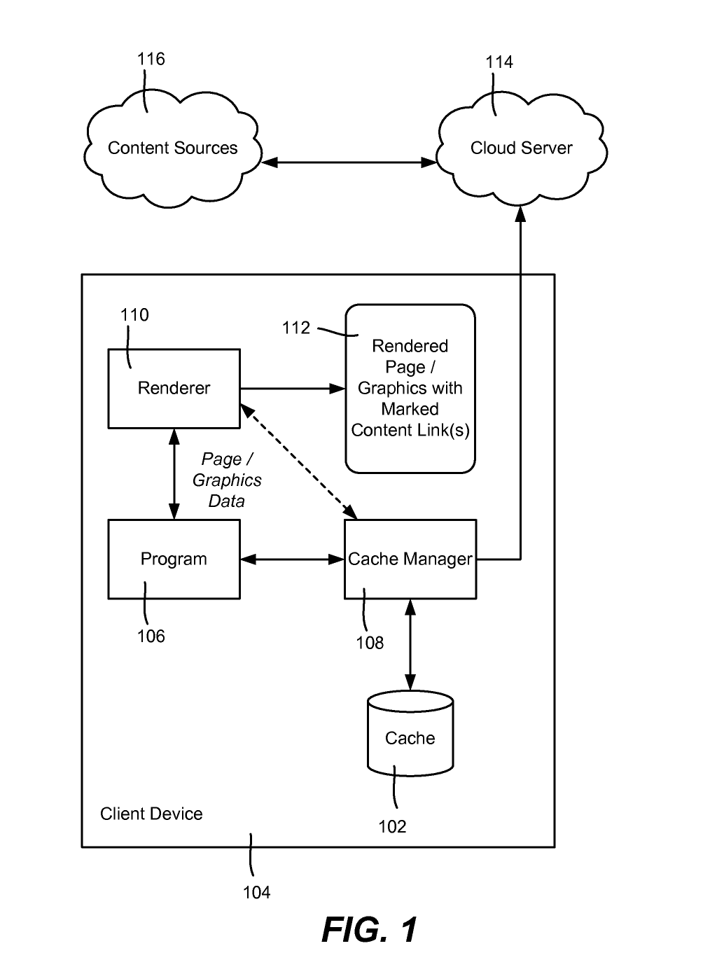

FIG. 1 shows a block diagram comprising an example system for providing an indication to users as to the state of content in a device cache 102 of a client device 104. A program 106, such as an application program or operating system component, which includes UI that displays an interactive link to a piece of content, communicates with a device cache manager 108 to obtain the state of the cache 102 with respect to the piece of content. Alternatively (as indicated in FIG. 1 via the dashed arrow), a renderer 110, such as a program component that is shared by other programs, may communicate with the cache manager 108 to obtain the cache-related status of any link that the renderer 110 renders, (or only a set of one more links as specified by the program 106), when the renderer 110 outputs the page/graphics 112 to the device display.

In one aspect, by maintaining (or receiving from the cache manager 108) information about which data resides on the client device 102, a “Cloud” server 114 or the like may optimize the cache 104 relatively aggressively. For example, the server 114 may pre-populate and/or update the cache 104, which may include predicting what the user is going to want or need. The server may only send and/or update content that is not already cached or expired. In this way, the cloud server 114 and cache manager 108 may communicate to automatically keep the device cache 104 relatively populated and up to date with likely relevant content. Learned user history, prior access patterns, user preference data and so forth may be used to predict what content a user is likely to want cached (and possibly when), whereby the cloud server 114 and cache manager 108 automatically pre-fetch such content into the cache 104 in anticipation of need, such as at night when the power is recharging and when the device has a high bandwidth (e.g., Wi-Fi) connection, or possibly on demand based upon an anticipated user desire for the content.

Further, stale content in the cache 104 may be updated in part rather than replaced by fresh content, by compressing data using the knowledge of what is already cached on the client device 102. For example, the server 114 may only send the parts of a cached web page that have changed, that is, the deltas to any piece of cached content needing updating.

The Cloud server 114 may also detect when (e.g., frequently accessed) online content changes at remote sources 116, and send updates at an appropriate (predicted) time to keep the client device's cache 104 fresh. The Cloud server 114 and/or cache manager 108 may manage any of a user's devices in this way, and can save energy by batching together data of separate requests or even from separate programs that need to have content fetched and/or pre-fetched, possibly piggybacking on other transactions with the client to save the energy of powering up the client radio for extra transmissions.

With this approach, the cache 104 on the client device 102 can be kept full of useful, fresh content, while potentially consuming less power due to fewer total radio transactions. However, with a large number of documents cached, the user will experience that some content (that which is cached) is very fast to access, while other content (that which is not cached) is considerably slower to access. As described herein, by notifying the user of the state of the content with respect to caching, the user's decision as to whether to access the content may be influenced, saving bandwidth and power whenever a user decides not to request remote content.

To this end, in one aspect the cached state of linked content is displayed by augmenting (modifying in some way) the displayed link to the content. For example, hyperlinks, names of e-mail attachments, and/or other links to content may appear differently based upon the cache status of the content to which the links point. Because clicking on a cached link typically provides a significantly better user experience (including retrieval speed, saving bandwidth, saving energy and so forth) relative to having to fetch the content from a remote source, most users will at least contemplate whether remote fetching is worthwhile for a given piece of content.

The links may be any type of link to cached or remote content, such as links in a webpage, a list of favorites/bookmarks, or one or more links in an email document, a word processing document, a spreadsheet and so forth. Thus, different programs may use a link augmented with cached-related state data to convey cache status information. For example, a browser may show a set of links on a search result page, with the user likely considering whether to select a link depending on the cached or not cached status of the corresponding content. A user may interact with a program to see a list favorites, with the cache status of each listed favorite conveyed to the user when the list is rendered. An application program that fetches and outputs content (e.g., sports news) can have its launching icon modified based upon cache status.

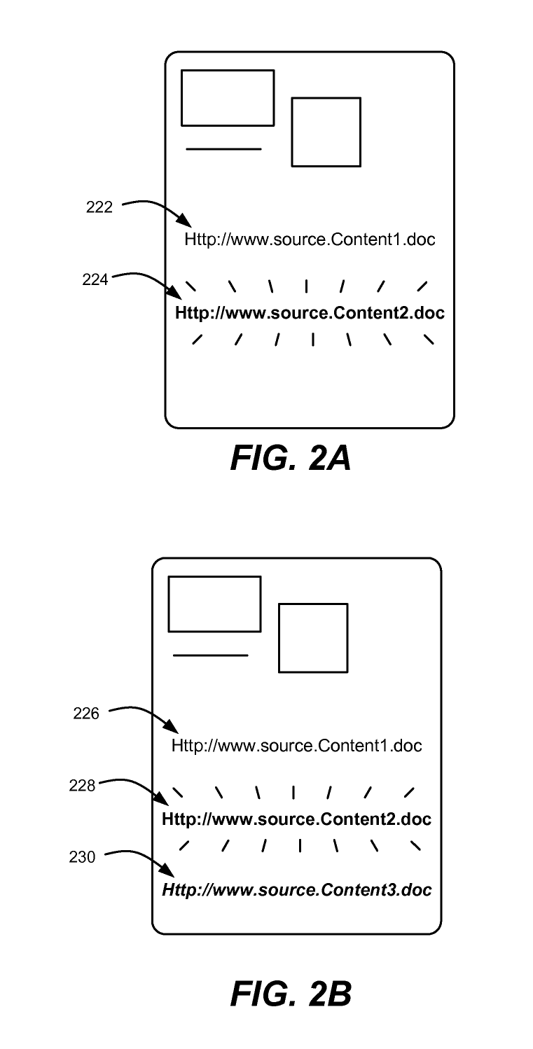

In one example, to augment the visible representation of the link, the program 106 or the renderer 110 visibly “marks” links to display each link's corresponding cached content's state to a user. One such indication, generally represented in FIG. 2A, may be cached or not cached. For example, as represented in FIG. 2A, a link 222 to content that is not cached may appear as conventionally displayed link, while a link 224 that is cached may be emphasized in some way. Note that while FIG. 2A shows a distinction between links on the same rendering, a consistent indication mechanism (e.g., color scheme) may be used such that users quickly learn to recognize the cached state of a link's content even when only a single link appears on a page, or when all displayed links corresponding to the same caching state.

The emphasis may be provide via color, by bolding, by glowing, by blinking, animation, oscillation, and so forth, or any combination thereof. The emphasis may occur at all times, or alternatively, when hovering over such a link (in a pointer-device environment). Other feedback such as vibration and/or sound (e.g., when hovering over such a link) may be used instead of or in addition to visible feedback.

A link and/or augmentation to a link may also appear as an image in whole or part, and a video (set of images) and/or animated image also may be used. The image may be a tile or other user interface element that is a link to remote content, with some augmentation (possibly a different image in whole or part) indicating when the content is locally cached. A page that is cached may appear in a small pop-up icon thumbnail or the like. Another form of augmentation may be to use “call out boxes” or the like, such as when hovering the cursor over the link.

In contrast to FIG. 2A's example of binary cached or not cached states, FIG. 2B provides a more granular indication, e.g., to represent not cached, cached and fresh, and cached but stale. For example, a link 226 to content that is not cached may appear as conventionally displayed by the program as represented in FIG. 2B, whereas a link 228 that is cached and not stale may be emphasized in one way (e.g., bolded and flashing or glowing), and a link 230 that is cached but stale may be emphasized in a different way. Although for purposes of illustration bold and italic (but not flashing/glowing) are used for the link 230 to indicate cached but stale content, it is likely that a color scheme may be used in some implementations, e.g., one color for not cached, another for cached and not state, and a third color for cached but stale. Any scheme may be configurable, e.g., color-blind users may not want red and green, for example. Graying out and other visible rendering techniques that convey state information also may be used.

It should be noted that a link marked as stale may be interacted with differently by a user, depending on whether the user wants to quickly obtain the stale content or download a fresh copy. With a mouse for example, double-clicking versus single clicking, and/or right clicking may be used to differentiate whether to retrieve the content from the cache or from the remote source. With a touch screen device, tapping versus pressing and holding may be used. Other interaction techniques are feasible.

What is considered stale may be dependent on a number of factors. For example, user behavior may be learned per user (e.g., a particular user never wants stale content for a certain link, so do not display the “cached but stale” state for that link). Stock quotes may be considered stale after a few seconds, while news stories may be considered stale after an hour. Users may set individual preferences, or defaults may be used. Further, as described herein, regular or periodic communication between a server and the cache manager may be used to update the stale or not stale state of some or all of the pieces of content in the cache.

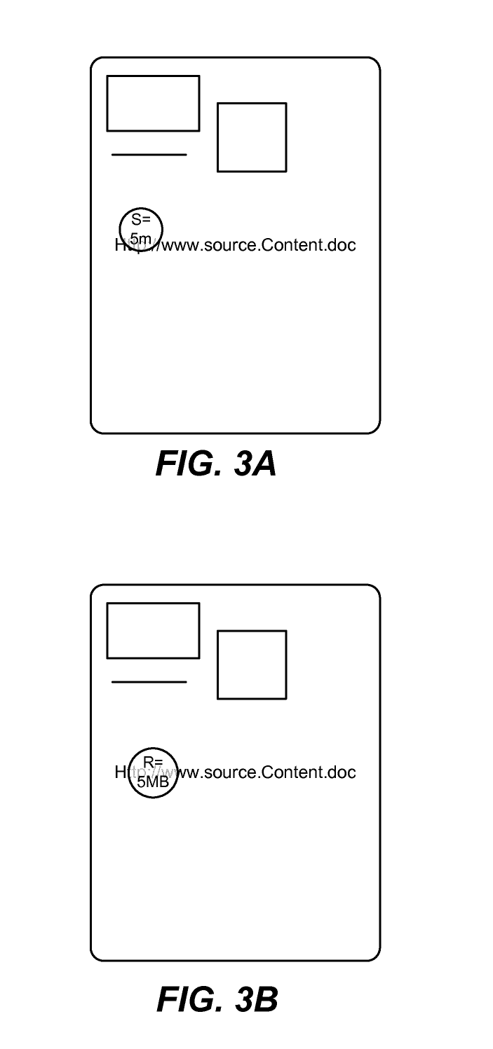

Another indication scheme, which may be used instead of or in conjunction with the schemes exemplified in FIGS. 2A and 2B, is to associate a marker with a link, as generally represented in FIGS. 3A and 3B. In the example of FIG. 3B, an icon shown as a semi-transparent circled “S=5 m” indicator overlays the link to content, whereby the “S=5 m” indicates cached but stale, with the amount of time stale (staleness equals five minutes) also represented in the icon. In this example, different icons, lettering and/or emphasis schemes may be used for other states if desired, e.g., a blue “C” for cached and not stale and/or highlighted/glowing, and a red “R” (or no indication at all) for remotely located content.

For stale or remote content, information (if known) about the content may be displayed. For example, in FIG. 3B, a circled indication “R=5 MB” appears above the link to indicate that the document is remote and five megabytes in size, whereby the user will consider whether such a large document is worthwhile downloading before activating the link.

Other information that may be conveyed includes the current communication speed of the device, which may be used in conjunction with the content's size. For example, if a connection is slow and/or a document is large, information to inform the user of the time for downloading may be provided, e.g., by graying out a link to non-cached content more the longer the download will take, or displaying an estimated time (e.g., “T=20 s”) in association with the link. How much data a user has left in his or her data plan (possibly influenced by when the next billing cycle resets the amount) also may be displayed, so that the user is aware of the possibility of incurring additional charges if a link to non-cached content is clicked.

Another caching state that may be conveyed to a user may be cache update pending, e.g., to indicate that content that is stale or not yet cached is currently being updated (e.g., possibly via delta updates as described herein) or downloaded to the cache, respectively. For example, consider that the cache manager and Cloud server is automatically updating the cache because the device or server has learned that the user always or almost always clicks on a link in an email message, and one such has just been displayed to the user in an email message. In another example, the cache manager may be in the middle of a periodic cache update. Letting the user know of the cache update pending state may influence the user to wait (e.g., until the link changes color) before clicking, so as to not independently request a download. The requesting program and/or cache manager may enforce such a wait, and also may change the priority of downloaded content it has not yet requested so as to retrieve the most likely desired content sooner in the cache updating process.

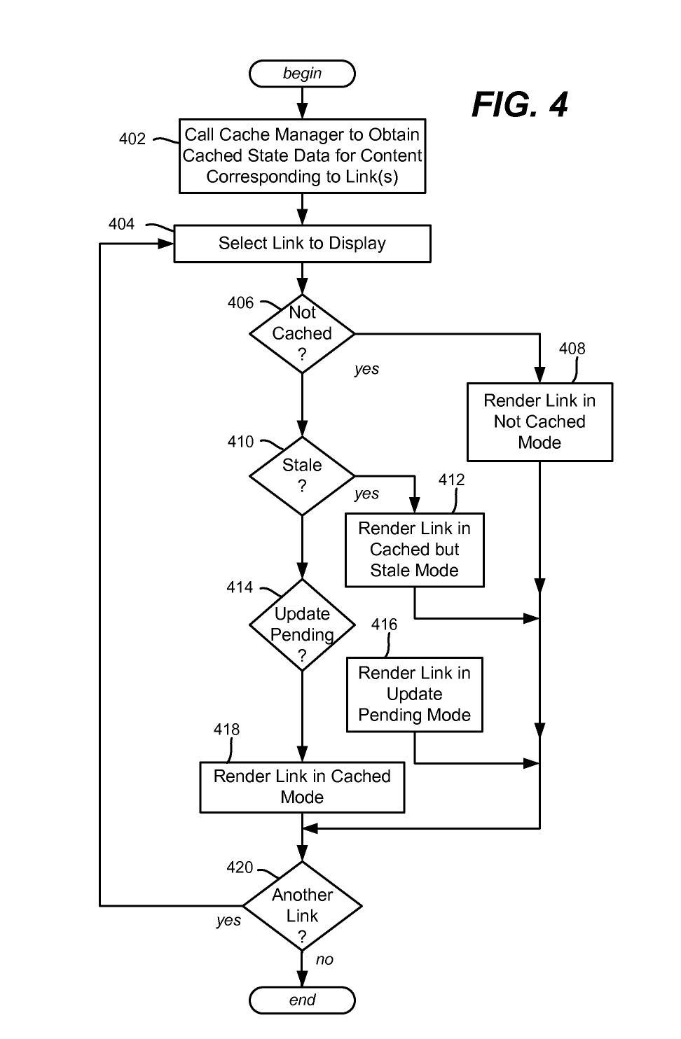

FIG. 4 is a flow diagram comprising example steps related to augmenting one or more links based upon the corresponding content's cache status. As represented by step 402, a program (or a renderer) passes the cache manager a set of one or more link targets, e.g., through an API call, and in response receives the cached state of the content corresponding to each link in the set. Note that FIG. 4 handles multiple links with a single call; an alternative is to have a separate call for each link.

Step 404 represents selecting a link to display and (possibly augment depending on the scheme), e.g., initially the first one to be rendered if multiple links are to be rendered. Steps 406 and 408 represent handling the not cached state, e.g., rendering the link (or preparing the link for later rendering) in the not cached mode of representation. Steps 410 and 412 represent handling the cached but stale state. Steps 414 and 416 represent the handling the update pending mode, if such a mode exists on a device. Step 418 represents handling the rendering of the link in the cached mode. Step 420 repeats the process for each link to be rendered.

Although not shown, a callback, notification/event or the like may be used if the status changes after the cache manager has returned the cache-related status for any link. For example, if a link corresponds to content that is pending an update, the cache manager can return pending update, and then callback or send a notification to the program or renderer once the content is updated.

As described above, many different formats for the augmentation are feasible, including having a link appear differently (e.g., glow or oscillate by changing size and/or position over time) if its linked content is cached, having a pop-up icon appear over the link when it is cached, having the links appear in a different format (typeface, color, boldness, slant, with animation, one or more effects such as blinking, oscillating, moving, background, and/or the like). This may be when displayed, or (in a pointing-device environment) when the user's pointer hovers over the link. Other relevant semantic information may also be conveyed, such as freshness of cached data, size of the file, and so forth.

Augmentation (or lack thereof) also indicates links to content pieces that are not cached, for example, to warn users that those links may be slow. In this way, the user can differentiate between fast and slow content, which may affect the user's choice of whether to access content and/or which content to access.

### Example Operating Environment

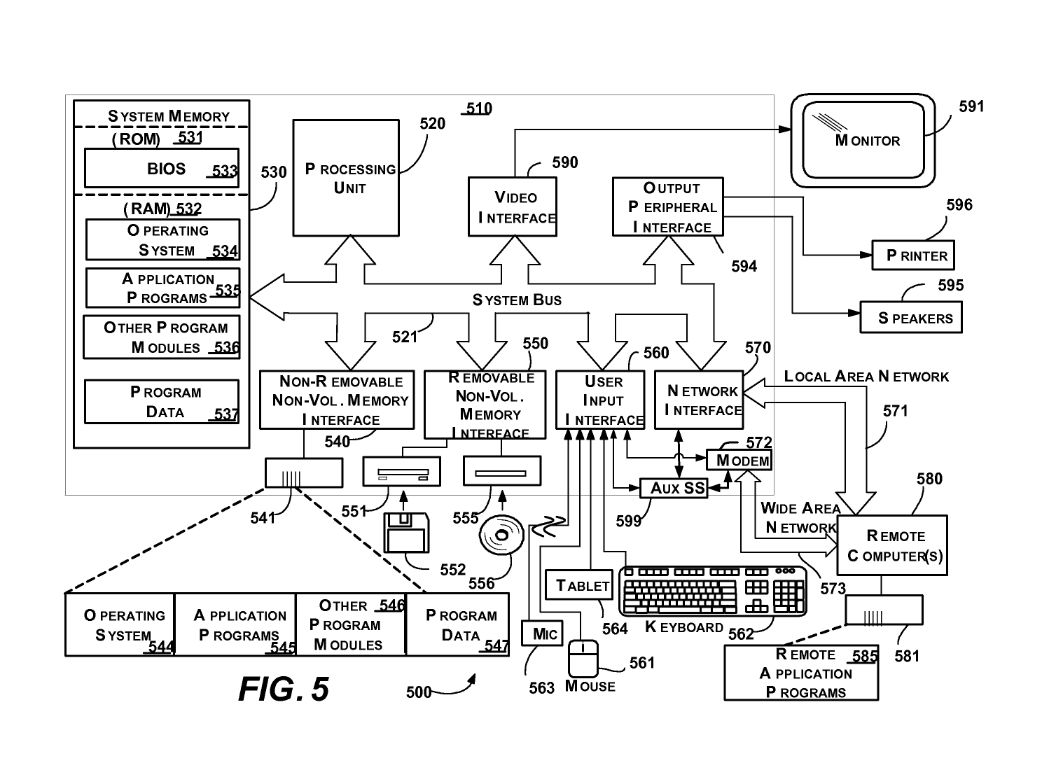

FIG. 5 illustrates an example of a suitable computing and networking environment 500 into which the examples and implementations of any of FIGS. 1-4 may be implemented, for example. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the example operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an example system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are examples and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising, obtaining cache-related status of content corresponding to a link, and rendering the link to indicate the cache-related status.

2. The method of claim 1 wherein obtaining the cache-related status of the content corresponding to the link comprises receiving information indicating that the content is cached, and wherein rendering the link to indicate the cache-related status comprises visibly augmenting a displayed representation of the link.

3. The method of claim 2 wherein visibly augmenting the displayed representation of the link to indicate that the content is cached comprises changing appearance of the displayed representation of the link relative to when the content is not cached, including changing at least part of an image, augmenting an image, changing color, changing typeface, changing slant, changing boldness, changing size, changing background, associating the displayed representation of the link with animation, or associating the displayed representation of the link with one or more effects, or any combination of changing at least part of an image, augmenting an image, changing color, changing typeface, changing slant, changing boldness, changing size, changing background, associating the displayed representation of the link with animation, or associating the displayed representation of the link with one or more effects.

4. The method of claim 2 wherein visibly augmenting the displayed representation of the link comprises associating an icon with the displayed visible representation of the link.

5. The method of claim 4 further comprising, providing information in the icon indicative of staleness, content size, connection speed, download time, or data plan-related information, or any combination of staleness, content size, connection speed, download time or data plan-related information.

6. The method of claim 1 further comprising, pre-fetching content into a device cache to change the cache-related status of the content.

7. The method of claim 1 further comprising, updating content in a device cache to change the cache-related status of the content.

8. The method of claim 7 wherein updating the content comprises sending changed content to modify part of an existing piece of content in the cache to provide an updated piece of content.

9. The method of claim 1 wherein rendering the link to indicate the cache-related status comprises visibly augmenting a displayed representation of the link, including augmenting the displayed representation of the link in one rendering mode for content having a cache-related status of cached and not stale and another, different rendering mode for content that is cached but stale.

10. The method of claim 1 wherein rendering the link to indicate the cache-related status comprises visibly augmenting a displayed representation of the link, including augmenting the displayed representation of the link to indicate when the content is pending an update in the cache.

11. A system comprising:
a memory comprising one or more types of storage media, at least part of the memory configured as a cache for content; and
one or more processors operatively coupled to the memory and which executes code stored in the memory, the one or more processors, in response to execution of the code, being configured to:
write content to the cache,
obtain cache-related status information of a piece of content corresponding to a link, and
render the link based upon the cache-related status information to convey the cache-related status of the piece of content corresponding to the link.

12. The system of claim 11 wherein the one or more processors execute a cache manager program and a program configured to render the link, the program configured to render the link calling the cache manager program to obtain the cache-related status information.

13. The system of claim 11 further comprising a display, the one or more processors configured to render the link as a visible representation of the link on the display, including providing different visible representations of the link when in different states as indicated by the cache-related status information.

14. The system of claim 11 further comprising a display, the one or more processors configured to render the link as a visible representation of the link on the display, and to provide an icon in association with the visible representation of the link for at least one state that is based upon the cache-related status information.

15. The system of claim 11 wherein the cache-related status information indicates that the content is cached, and wherein the one or more processors render the link in at least one rendering mode to indicate that the content is cached and not stale relative to at least one other rendering mode when the content is cached but stale.

16. The system of claim 11 wherein the one or more processors are further configured to execute code that pre-fetches content into the cache or updates content in the cache, or both pre-fetches content into the cache and updates content in the cache.

17. One or more computer-readable media having computer-executable instructions, which when executed perform steps, comprising, determining whether a piece of content corresponding to a link is cached, and if not cached, rendering a visible representation of the link in one mode, and if cached, rendering a visible representation of the link in another mode.

18. The one or more computer-readable media of claim 17 having further computer-executable instructions comprising, determining whether the piece of content corresponding cached and not stale or cached but stale, and if cached and not stale, rendering a visible representation of the link in the other mode in a cached and not stale rendering mode, and if cached but stale, rendering a visible representation of the link in the other mode in a cached but stale rendering mode.

19. The one or more computer-readable media of claim 17 wherein rendering the visible representation of the link in at least one of the one mode or the other mode comprises rendering the visible representation of the link in association with an icon.

20. The one or more computer-readable media of claim 19 having further computer-executable instructions comprising, outputting information in the icon that conveys staleness-related information of the content or size-related information of the content, or both staleness-related information of the content and size-related information of the content.
